(19) United States
(12) Patent Application Publication
(10) Pub. No.: US 2011/0024351 A1
(43) Pub. Date: Feb. 3, 2011

(54) METHOD AND APPARATUS FOR BIOLOGICAL TREATMENT OF SPENT CAUSTIC

(76) Inventor: Albert Joseph Hendrik Janssen, Amsterdam (NL)

Correspondence Address: SHELL OIL COMPANY, P O BOX 2463, HOUSTON, TX, 772522463, US

(21) Appl. No.: 12/867,194

(22) PCT Filed: Feb. 11, 2009
(86) PCT No.: PCT/EP09/51527

§ 371 Date: Oct. 7, 2010

(30) Foreign Application Priority Data
Feb. 13, 2008 (EP) 08101581.0

(51) Int. Cl. C02F 3/00; C02F 3/34

(52) U.S. Cl. 210/601; 210/201

(57) ABSTRACT

The invention provides a method and apparatus for biologically treating a spent caustic to provide a treated spent caustic, said method comprising the steps of: (a) passing a spent caustic stream (25) comprising water, alkali metal hydroxide and sulphide to a first bioreactor (30); (b) biologically oxidising sulphide in the first bioreactor (30) with sulphide-oxidising bacteria to form sulphur) (S⁰) and sulphate to provide a partially oxidised spent caustic comprising sulphur) (S⁰) and sulphate; (c) passing the partially oxidised spent caustic to a second bioreactor (40) where at least a portion of the partially oxidised spent caustic is further oxidised with sulphide-oxidising bacteria to generate sulphate from sulphur) (S⁰) to provide a treated spent caustic comprising sulphate.

The invention relates to a method and apparatus for the biological treatment of spent caustic, particularly spent caustic having a high chemical oxygen demand (COD), and an apparatus therefor.

The treatment of natural gas and the petroleum refining industry utilises sodium hydroxide (caustic) solutions to remove hydrogen sulphide (H₂S) and other organic sulphur compounds such as mercaptans (RSH, R being an alkyl- or aryl substituent) from hydrocarbon streams. The hydrogen sulphide in the hydrocarbon stream is first dissolved in solution to form an aqueous species:

H₂S(g)⇄H₂S(aq) (1)

Aqueous hydrogen sulphide then reacts with the hydroxide anion in the caustic solution to form the HS⁻ anion and water:

H₂S(aq)+OH⁻⇄HS⁻+H₂O (2)

Similarly, mercaptans are converted to RS⁻. Both HS⁻ and RS⁻ can be further deprotonated to S²⁻. As used herein in the specification and claims, the terms “sulphide” and “sulphide anion” represent one or both of the S²⁻, HS⁻ or RS⁻ anions.

Once the hydrogen sulphide is absorbed in the sodium hydroxide solution, the solution becomes known as a spent caustic. Spent caustics can have a pH of ≧9, typically ≧10, sulphide concentrations exceeding 2-3 wt %, and a large amount of residual alkalinity. Depending on the hydrocarbon stream treated, the spent caustics may also absorb one or more compounds selected from the group consisting of: thiols, phenols and amines.

Processes for the biological treatment of a spent caustic containing sulphides are known in the art and for example described in U.S. Pat. No. 6,045,695. In the process described in U.S. Pat. No. 6,045,695, a spent caustic solution is introduced into a single aerobic reactor containing sulphide-oxidising bacteria, and the sulphides are partly converted to elemental sulphur and partly to sulphate by controlling the redox potential in the reactor at a value below −300 my against a Ag/AgCl electrode. A disadvantage of the process described in U.S. Pat. No. 6,045,695 is that a very large reactor is needed in order to convert the spent caustic to levels low enough to meet modern regulatory requirements for discharge into the environment. A need exists for an improved method and apparatus for treating spent caustic which meet effluent discharge standards.

Thus, the invention provides a method of biologically treating a spent caustic to provide a treated spent caustic, said method comprising the steps of:

(a) passing a spent caustic stream comprising water, alkali metal hydroxide and sulphide to a first bioreactor;
(b) biologically oxidising the sulphide in the first bioreactor with sulphide-oxidising bacteria to form sulphate and sulphur (S⁰) to provide a partially oxidised spent caustic comprising sulphate and sulphur) (S⁰);
(c) passing the partially oxidised spent caustic to a second bioreactor where at least a portion of the partially oxidised spent caustic is further oxidised with sulphide-oxidising bacteria to generate sulphate from sulphur) (S⁰) to provide a treated spent caustic comprising sulphate.

In step (b), a rapid non-biological oxidation to thiosulphate will also occur. This results in a detoxification of the solution because the majority of the toxic sulfides are removed. Thus, in step (c) sulphate is generated not only from sulphur but also from thiosulphate.

In a preferred aspect, the method of the invention provides a treated spent caustic which has a sulphide content of less than 1 mg/l. Preferably, the treated spent caustic may also have a chemical oxygen demand (COD) value of less than 150 mg/l. Furthermore, the effluent may also have a biological oxygen demand (BOD) value of less than 30 mg/l. The effluent typically also has a pH in the range of 6 to 9.5, preferably 6 to 9.

Suitably, the partially oxidised spent caustic comprises one or more compounds selected from the group of sulphate, sulphur, thiosulphate and polysulphides.

Suitably, the treated spent caustic comprises sulphates. Preferably, the treated spent caustic comprises at least 80%, more preferably at least 90% and still more preferably at least 95% of sulphates.

The sulphide anions, such as HS⁻ are consumed by sulphide-oxidising bacteria (SOB) in the first bioreactor to form sulphate and elemental sulphur. The sulphate is formed according to the following reaction:

HS⁻+2O₂→SO₄²⁻+H⁺ (3)

It is apparent that the sulphate forming oxidation liberates acidic protons which will lead to a reduction in the pH of the spent caustic in the first bioreactor. However, under lower oxygen concentrations, suitably below 2.0 mg/l, which may occur in certain zones of the first bioreactor in which oxygen transport is diminished, elemental sulphur and hydroxide may be formed according to the following reaction:

HS⁻+0.5O₂→S⁰+OH⁻ (4)

It is apparent that the foregoing reaction, which produces hydroxide anions, can lead to a regeneration of the alkaline potential of the spent caustic. Consequently, it is preferred to encourage reaction (3) compared to reaction (4) in order to lower the pH of the caustic and lower the COD of the treated spent caustic. This can be achieved by controlling the redox potential of the bioreactor or by controlling the DO setpoint value. This is discussed in greater detail below.

Thiosulphate is an undesirable by-product of the oxidation of hydrogen sulphide because it has a high COD. Thiosulphate may be formed in a bioreactor by the abiotic (non-biological) two-step process shown in reactions (5) and (6). In reaction (5), the elemental sulphur produced by the action of the SOB, for instance according to reaction (4) above, reacts with further sulphide to form anionic Sₓ²⁻ species and protons.

(x−1)S⁰+HS⁻⇄Sₓ²⁻+H⁺ (5)

This reaction is in equilibrium at a pH of approximately 8.5. At higher pH, and especially under natronophilic conditions, the Sₓ²⁻ product is favoured. At lower pH, the equilibrium shifts to the reactants, favouring the sulphur and sulphide anion.

Under alkaline conditions, such as those present in the first bioreactor, the Sₓ²⁻ anion can react with oxygen to form thiosuphate and regenerate elemental sulphur, as shown in the following reaction:

Sₓ²⁻+1.5O₂→S₂O₃²⁻+(x−2)S⁰ (6)

Thiosulphate may also be produced by the abiotic oxidation of the sulphide anion according to the following reaction:

HS⁻+O₂→0.5S₂O₃²⁻+0.5H₂O (7)

The residence time of the spent caustic in the first bioreactor is such that substantially all of the sulphide anions are consumed by the SOB. In this way, the concentration of hydrogen sulphide ions in the first bioreactor can be reduced to less than 1 mg/l. Consequently, the effluent from the first bioreactor, which provides the feed to the second bioreactor as a partially oxidised spent caustic stream, is substantially free of sulphide anion. For instance, the effluent from the first bioreactor can contain less than 10 mg/l HS⁻, more preferably less than 1 mg/l HS⁻.

At least a portion of the partially oxidised spent caustic is further oxidised with sulphide-oxidising bacteria in the second bioreactor to generate sulphate from sulphur (S⁰).

It will be apparent that the absence of sulphide from the feed to the second bioreactor will eliminate the possibility of reactions (5) and (7) occurring in the second bioreactor. This prevents the formation of further thiosulphate, particularly by the abiotic oxidation of Sₓ²⁻ species (reaction (6) above), which are formed by the reaction of elemental sulphur with HS⁻ (reaction (5) above).

The elimination of HS⁻ from the second bioreactor enables the SOB to oxidise the elemental sulphur produced in the first bioreactor via reaction (4) to sulphate in accordance with the following reaction:

S⁰+1.5O₂+H₂O→SO₄²⁻+2H⁺ (8)

In addition, the SOB can also oxidise any thiosulphate present in the second bioreactor to sulphate, such as in accordance with the following reaction:

S₂O₃²⁻+2O₂+2OH→2SO₄²⁻+H₂O (9)

thus further reducing the level of thiosulphate.

In contrast, conventional systems utilising a single bioreactor contain high concentrations of sulphide. As a result of the high sulphide concentrations, reactions (5) and (7) compete with reactions (3) and (4) to consume the sulphide. Consequently, significantly more thiosulphate is produced in single bioreactor systems. Furthermore, reaction (5) will also compete with reaction (8), the latter of which converts elemental sulphur to sulphate. Thus, less sulphide is ultimately converted into sulphate in a conventional system. Another disadvantage of the one-step process is that concentration gradients within the system may exist, elading to undesired side-reactions (e.g. thiosulphate and sulphur formation).

In one embodiment of the present invention, the partially oxidised spent caustic exiting the first bioreactor is substantially free of sulphide. By “substantially free” is meant that the concentration of sulphide is less than 10 mg/l, preferably less than 5 mg/l, more preferably less than 1 mg/l and most preferably less than 0.5 mg/l.

The spent caustic comprises sulphide, water and alkali metal hydroxide, preferably sulphide, water and sodium hydroxide.

It is preferred that the method further comprises the step of filtering the treated spent caustic to provide a treated water stream. The filtering is preferably by continuous microfiltration or ultrafiltration. It is preferred that the treated water stream has a sulphide content of less than 1 mg/l, more preferably less than 0.5 mg/l. Furthermore, it is preferred that the treated water stream from the treatment of the spent caustic meets the World Bank Group effluent discharge standards defined in Table 1.

TABLE 1
World Bank Group Effluent
Discharge Standards

| Property | Limit |
|---|---|
| PH | 6-9 |
| BOD | 30 mg/l |
| COD | 150 mg/l |
| TSS | 30 mg/l |
| Sulfide | 1 mg/l |
| Nitrogen | 10 mg/l |

In the case the effluent pH is too high, pH correction is needed by addition of an acid (preferably HCl or H₂SO₄).

In a further embodiment, the partially oxidised spent caustic comprises sulphate and sulphur.

In another embodiment, the treated spent caustic mainly comprises sulphate. Preferably, the treated spent caustic comprises less than 1 mg/l and most preferably less than 0.5 mg/l sulphide.

In a further embodiment, the redox potential of one or both of the first and second bioreactors is controlled, preferably at a value above −300 mV versus a standard Ag/AgCl reference electrode.

In a further embodiment, the first and second bioreactors are operated as a continuous culture. Preferably the first and second bioreactors are continuous-flow gaslift reactors. In the case of smaller reactors, aerated bubble columns may also be used.

In another embodiment, the sulphide-oxidising bacteria is of a genera selected from the group consisting of thiobacillus, thiomicrospira and haloalkaliphilic bacteria.

In a second aspect, the invention provides an apparatus for the biological treatment of a spent caustic comprising at least:

a first bioreactor having a first inlet for a spent caustic feed stream comprising water, alkali metal hydroxide and sulphide and a first outlet for a partially oxidised spent caustic stream comprising sulphate and sulphur (S⁰);

a second bioreactor having a first inlet connected downstream to the first outlet of the first bioreactor, and a first outlet for providing a treated spent caustic stream comprising sulphate;

wherein said first bioreactor comprises a first medium comprising a sulphide-oxidising bacteria which generates sulphate and sulphur (S⁰) from sulphide and said second bioreactor comprises a second medium comprising a sulphide-oxidising bacteria which generates sulphate from sulphur (S⁰).

In a further embodiment, the first outlet of the second bioreactor is connected to the first inlet of a separation device, which has a first outlet for a treated water stream. It is preferred that the separation device comprises a microfilter or a sandfilter.

In another embodiment, the sulphide-oxidising bacteria in the first and second media of the first and second bioreactors is of a genera selected from the group consisting of thiobacillus and thiomicrospira.

In a further embodiment, one or both of the first and second bioreactors further comprise a redox device for controlling the redox potential of one or both of the first and second media. Alternatively, a DO measurement can be used.

In another embodiment, the first bioreactor further comprises a second inlet connected to a water feed stream. The first bioreactor may also further comprise a nutrient feed stream inlet connected to a nutrient feed stream. Additionally, the first bioreactor may further comprise an oxygen feed stream inlet connected to a first oxygen feed stream, and a second outlet connected to a first gaseous effluent stream.

In a further embodiment, the second bioreactor may further comprise a second inlet connected to a second oxygen feed stream, and a second outlet connected to a second gaseous effluent stream.

Embodiments of the invention will now be described by way of example only, and with reference to the accompanying non-limiting drawings in which:

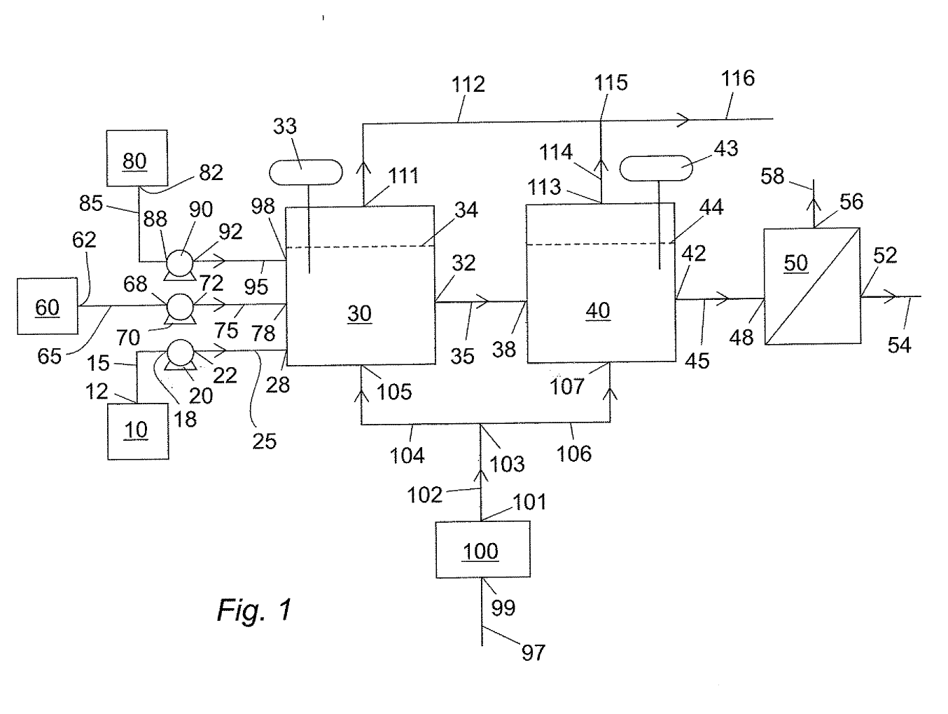

FIG. 1 is a schematic frawing of an apparatus according to the invention.

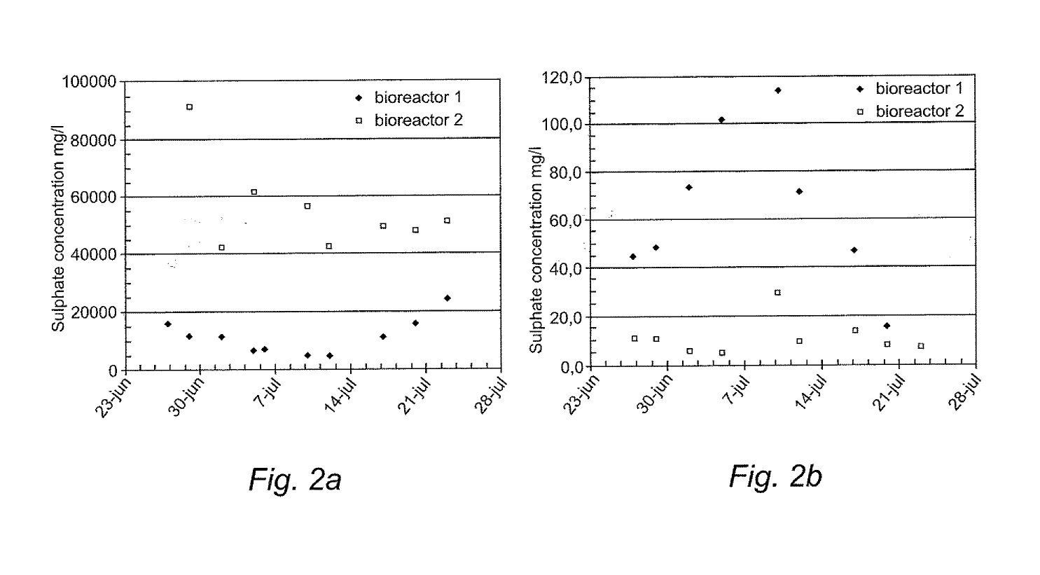

FIG. 2A is a plot of sulphate concentration versus time for the first and second bioreactors of an embodiment of the invention. FIG. 2B is a plot of thiosulphate concentration versus time for the first and second bioreactors.

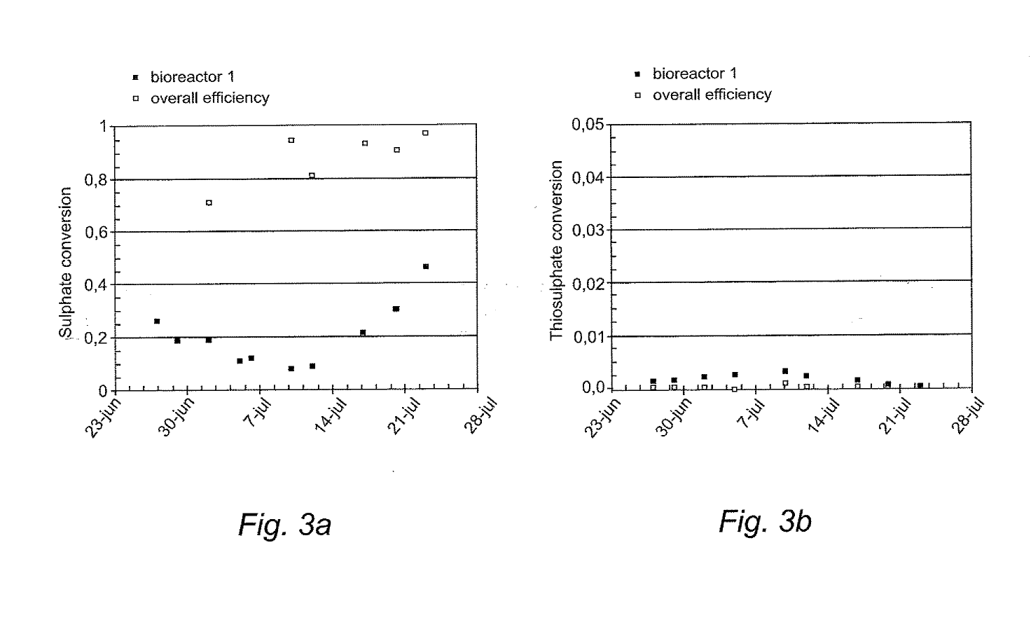

FIG. 3A is a plot of sulphate conversion versus time for the first bioreactor and for the overall efficiency of an embodiment of the invention. FIG. 3B is a plot of thiosulphate conversion versus time for the first bioreactor and for overall efficiency of the invention.

Hydrogen sulphide and/or mercaptans from a process stream, such as a stream from the treatment of natural gas or the refining of petroleum, is first dissolved in the aqueous caustic solution, as described in reaction (1) above. Absorption of hydrogen sulphide and/or mercaptans by the caustic leads to the formation of sulphide anions in accordance with reaction (2). The ionisation of hydrogen sulphide liberates H⁺ (aq) species which are neutralised by the hydroxide ions in the caustic to form water. Reaction (2) therefore leads to a reduction in the pH of the solution. After absorption of the hydrogen sulphide gas by the solution a spent caustic is produced. The spent caustic is then transferred to spent caustic supply tank 10.

The apparatus of the invention shown in FIG. 1 comprises spent caustic supply tank 10, first bioreactor 30, second bioreactor 40, separating device 50, water supply tank 60, nutrient supply tank 80 and humidifier 100.

Spent caustic supply tank 10 holds spent caustic which can be provided from any source, such as a natural gas treatment plant or a petroleum refinery. The spent caustic is formed by the absorption of hydrogen sulphide gas, together with any other sulphur-containing compounds such as mercaptans (e.g. methyl mercaptan) and organic sulphides (e.g. dimethyl sulphide and dimethyl disulphide), by a caustic such as an alkali metal hydroxide solution, for instance a solution comprising sodium hydroxide. The caustic may further comprise additional components such as alkali metal acetates, such as sodium acetate.

The spent caustic is withdrawn by pump 20 as spent caustic supply stream 15 from spent caustic supply tank 10 via outlet 12. The spent caustic supply stream 15 is drawn into pump 20 through inlet 18 and exits through outlet 22 as spent caustic stream 25. Spent caustic stream 25 is passed to first bioreactor 30 via first inlet 28.

The first bioreactor 30 is also fed with a water feed stream 75 provided by a water supply tank 60 via pump 70. The water may be of any type such as mains (tap) water or purified water, or cleaned process water, typically distilled water. A water supply stream 65 is withdrawn from water supply tank 60 via outlet 62 and drawn into pump 70 via inlet 68. The water exits pump 70 via outlet 72 as water feed stream 75 and is passed to the first bioreactor 30 via second inlet 78.

The first bioreactor 30 is further fed with a nutrient feed stream 95 provided by a nutrient supply tank 80 via pump 90. The nutrients may be of any type used conventionally and are suitably selected from the group of N, P, K and trace metals. A nutrient supply stream 85 is withdrawn from nutrient supply tank 80 via outlet 82 and drawn into pump 90 via inlet 88. The nutrient solution exits pump 90 via outlet 92 as nutrient feed stream 95 and is passed to the first bioreactor 30 via nutrient feed stream inlet 98.

Oxygen is supplied to the first bioreactor 30 at oxygen feed stream inlet 105 by first oxygen feed stream 104. First oxygen feed stream 104 is formed by splitting a combined oxygen feed stream 102 at stream splitter 103. The oxygen stream may comprise air or a concentrated oxygen composition, such as pure oxygen. Gas is removed from first bioreactor 30 by first gaseous effluent stream 112, via second outlet 111.

The first bioreactor 30 comprises a first medium of an active culture of sulphide-oxidising bacteria. This can be provided by inoculation prior to starting pump 20 and providing spent caustic stream 25 to the bioreactor. It is preferred that the oxidation is carried out using sulphide-oxidising bacteria of the genera Thiobacillus, Thiomicrospira and related organisms. Bacteria of the genus Thiobacillus, such as Thiobacillus thioparus are known to produce sulphate and sulphur from sulphide.

The SOB may also be derived from the full-scale sulphide-oxidising bioreactor at Nuon Aviko, Steenderen and aerobic sludge from their waste water treatment plant. The bacteria can be used in free form, dispersed on a carrier, or immobilised on a solid carrier. The first medium further comprises water. Line 34 shows one suitable level of the medium in the bioreactor. Once the culture is established biomass will also form in the first medium.

The SOB used in the present invention are generally used in a conventional manner. The salinity of the first bioreactor can be close to the value of seawater, for instance a salt (NaCl) concentration of between 30 to 40 g/kg, preferably 33 to 37 g/kg when SOB of the genera Thiobacillus, thiomicrospira and related organisms are used. The salinity of the first bioreactor can also be much higher than that of seawater. If a spent caustic of higher salinity is used, it can be diluted in first bioreactor 30 using water feed stream 75.

The SOB derived from the full-scale sulphide-oxidising bioreactor at Nuon Aviko, Steenderen and aerobic sludge from their waste water treatment plant can tolerate significantly higher salt concentrations of up to 80 g/kg, and is therefore useful with more concentrated spent caustics. This has the advantage that dilution of the spent caustic with water is not required, or less dilution is required compared to Thiobacillus or thiomicrospira genera.

The hydraulic residence time of the spent caustic in the first bioreactor is between 5 and 15 days, preferably approximately 10 days. This provides sufficient time for the oxidation of the sulphide anion in the spent caustic solution. The total hydraulic residence time in both eractors is preferably more than 24 hours. The hydraulic residence time in the first reactor is preferably more than 12 hours.

The SOB in the first bioreactor 30 converts the sulphide in the spent caustic to sulphate and sulphur by reactions (3) and (4) discussed above. However, at the high concentrations of sulphide found in spent caustic, it is inevitable that some of the sulphur produced in reaction (4) will react with unreacted sulphide to produce thiosulphate according to reactions (5) and (6). In addition, the high sulphide concentrations can also give rise to the abiotic oxidation of sulphide shown in reaction (7).

Thiosulphate-forming reactions (5) and (6) can be minimised by reducing the sulphide concentration in first bioreactor 30. The biological reactions proceed approximately 50 to 100 times faster than abiotic oxidation reaction (7). Consequently, reducing the concentration of sulphide favours the formation of sulphur and sulphate via reactions (3) and (4) and minimises abiotic oxidation reaction (7). It is therefore preferred that the sulphide load in the first bioreactor is below 2000 mg sulphide l⁻¹ hr⁻¹. It is further preferred that the sulphide load in the second bioreactor is below 500 mg sulphide l⁻¹ hr⁻¹.

The sulphide-oxidising reactions of SOB can also be controlled by adjusting the redox potential of the culture medium. An apparatus for controlling the redox potential of the medium is shown schematically in FIG. 1 as redox unit 33. At a redox potential between −360 and −300 my (against a Ag/AgCl reference electrode), sulphide is partially converted to elemental sulphide and sulphate. At redox potentials above −300 my, sulphate formation is favoured. Preferably the redox potential in the first bioreactor 30 is controlled such that sulphate is formed and by reaction (3) which in turn results in neutralisation of the spent caustic. By “neutralisation” it is meant a pH in the range of 6 to 9 is produced. Alternatively, DO control is used.

Once the sulphide in the medium of first bioreactor 30 has been consumed to provide sulphate and sulphur, this is passed to a second bioreactor 40 as partially oxidised spent caustic stream 35. Partially oxidised spent caustic stream 35 exits first bioreactor 30 via first outlet 32 and enters second bioreactor 40 via first inlet 38. Partially oxidised spent caustic stream 35 is substantially free of sulphide as discussed above.

The partially oxidised spent caustic passed to second bioreactor 40 provides a second medium in the second bioreactor. The second medium comprises the same SOB as the first medium in first bioreactor 30. The first and second bioreactors 30, 40 can therefore be operated as a continuous culture. Once the culture is established in the second bioreactor, biomass will also form. It is preferred that first and second bioreactors 30, 40 are continuous-flow gaslift reactors.

One suitable water level of the second medium is shown as line 44 in FIG. 1. Second bioreactor 40 performs two main purposes. The elemental sulphur produced in first bioreactor 30 can be oxidised to sulphate in accordance with reaction (8). A high residence time may be required in second bioreactor 40 because the elemental sulphur particles are not soluble in the second medium and are therefore less easily oxidised by the SOB. Residence times of the partially oxidised spent caustic in the second bioreactor can be between 5 and 15 days, preferably approximately 10 days in order to allow reaction (8) to proceed. This reaction also produces hydrogen ions which are beneficial in the further neutralisation of alkali metal hydroxide in the second medium.

In addition, the thiosulphate produced in first bioreactor 30 according to reactions (5) and (6) because of the presence of sulphide (HS⁻) can be further oxidised to sulphate in accordance with reaction (9). The elimination of sulphide in first bioreactor 30 means that second bioreactor 40 is substantially free of HS⁻. The two main processes for the production of thiosulphate, namely combined reactions (5) and (6) and reaction (7), require the presence of HS⁻. These reactions thus cannot occur in second bioreactor 40, and thiosulphate is not produced by these routes. Consequently, any thiosulphate produced in first bioreactor 30 may be oxidised to sulphate by reaction (9) in second bioreactor 40 without the formation of any further thiosulphate. Providing two bioreactors in this way produces a treated spent caustic in which the sulphide has been converted to sulphate and sulphur.

Oxygen is supplied to the second bioreactor 40 at second inlet 107 by second oxygen feed stream 106. Second oxygen feed stream 106 is formed from the splitting of combined oxygen feed stream 102 at stream splitter 103. The oxygen stream may comprise air or a concentrated oxygen composition, such as pure oxygen as discussed above for first oxygen feed stream 104. Gas is removed from second bioreactor 40 by second gaseous effluent stream 114, via second outlet 113. Second gas effluent stream 114 can be combined with first gas effluent stream 112 by gas combining device 115, to produce combined gaseous effluent stream 116. Combined gaseous effluent stream 116 can be recycled or sent to the atmosphere, preferably after passing through a filter. Suitable filters include a composite filter or a carbon filter for odour control.

In a preferred embodiment, combined oxygen feed stream 102 is humidified by a humidifier 100. The humidifier 100 increases the moisture content of first and second oxygen feed streams 104, 106 provided to the first and second bioreactors 30, 40. In some circumstances, evaporation from one or both of the first and second media in first and second bioreactors 30, 40 can reduce the water content, concentrating the sulphur-containing species, SOB and biomass present. In order to maintain the viability of the culture, make-up water may be added to the medium as moisture carried in first and second oxygen supply streams 104, 106. Humidifier 100 is provided with oxygen by oxygen supply stream 97, via inlet 99.

It is preferred that the oxidation reactions occurring in second bioreactor 40 are carried out under redox control, in a similar manner to first bioreactor 30 discussed above. Redox unit 43 is shown schematically in FIG. 1. Identical redox conditions to those discussed for first bioreactor 30 are used.

The treated spent caustic is withdrawn from second bioreactor 40 via first outlet 42 as treated spent caustic stream 45. Treated spent caustic stream 45 preferably comprises less than 1500, more preferably less than 1000 mg/l total suspended solids sulphur. Treated spent caustic stream 45 also preferably comprises less than 25, more preferably less than 10 mg/l, thiosulphate. Treated spent caustic stream 45 preferably has a conductivity in the range of 70 to 90 mS/cm, more preferably approximately 80 mS/cm.

In some cases, treated spent caustic stream 45 may contain excessive amounts of suspended solids such as biomass and elemental sulphur particles. These can be removed from treated spent caustic stream 45 by a post-oxidation filtering step. For instance, treated spent caustic stream 45 can be passed to a separation device 50 via first inlet 48. Separation device 50 can comprise a membrane filter. The membrane filter separates the suspended solids from the solution, preferably by continuous microfiltration or ultrafiltration, providing a treated water stream 54 which exits separation device 50 at first outlet 52, and a concentrated biomass and sulphur stream 58 which exits the separation device 50 at second outlet 56. Also, oil, grease and/or catalyst particles can be present. A solid/liquid separation step is then suitably applied.

In this way, the total suspended solids (including sulphur) in treated water stream 54 can be preferably reduced to less than 30 mg/l, more preferably less than 25 mg/l and even more preferably less than 20 mg/l.

The method and apparatus of the invention will now be illustrated by the following non-limiting Example.

### EXAMPLE 1

Two standard bioreactors, each of 2 l working volume were provided and constructed to be operated as a continuous culture. The bioreactors were inoculated with sludge. SOB were taken from a full-scale H₂S oxidation unit mixed with SOB from a soda lake. The temperature of the bioreactors was controlled by a water jacket at 30° C., providing an internal temperature in both reactors of 28±1° C.

The redox potential and the pH of each bioreactor were measured on-line using the oxidation-reduction potential. Nutrients were intermittently supplied by pulse/pause pump or manually. The bioreactors were provided with an air supply to aerate the solutions. The level of aeration was set such that the redox potential was greater than −100 mV/cm. The air supply was conditioned using a humidifier such that wet air was provided to the bioreactors. The humidity level of the air supply was set to maintain the liquid level in the bioreactors at a constant level.

Table 2 shows the composition of the synthetic spent caustic used. The initial feed rate of the spent caustic stream was set at 5 ml/hr for 4 days, and then raised to 9 ml/hr over the fifth day. Water was used to dilute the influent stream in the first bioreactor and a flow rate of 6-9 ml/hr was provided over the course of the treatment. The system had a hydraulic residence time of approximately 10 days.

TABLE 2
Spent caustic composition

| | Proportion |
|---|---|
| Component | (% w/w) |
| Sodium sulphide | 2.99 |
| Sodium hydroxide | 2.26 |
| Sodium acetate | 4.09 |
| Water | 90.66 |

The influent was analysed for sulphide and acetic acid. The effluent (partially oxidised spent caustic and treated spent caustic) of both bioreactors was analysed for sulphide, acetic acid, sulphate, thiosulphate, biomass (Laton N), conductivity and pH. Reactors were equipped with sensors for temperature, pH (Hamilton Flushtrode T200, Hamilton Reno, Nev.), DO concentration (Mettler Toledo Inpro 650/120 Mettler Toledo Greifensee, Switzerland) and oxidation-reduction potential (ORP, WTW SenTix ORP Ag/AGCl electrode, WTW, Weilheim, Germany). The DO concentration was measured as % saturation (% sat). The ORP was measured versus a saturated KCl, Ag/AgCl reference electrode. Sulphide concentration was measured as total sulphide.

Steady state conditions were reached by the end of the example. The pH of the first bioreactor remained at approximately 9.8. Although the production of sulphate from the hydrogen sulphide according to equation (3) produces acidic protons, hydroxide ions are produced with elemental sulphur from the oxidation of hydrogen sulphide according to equation (4). The production of hydroxide anions buffers the solution at a constant pH.

In the second bioreactor, the elemental sulphur was converted to sulphate in accordance with equation (8). This reaction also produces hydrogen ions, lowering the pH of the second bioreactor to approximately 9.3.

The conductivity of the first bioreactor stabilised at approximately 72 mS/cm. The conductivity of the second bioreactor stabilised at approximately 79 mS/cm. A higher conductivity was measured in the second bioreactor due to the evaporation of water and consequent concentration of the second medium.

The redox potential of the first bioreactor fluctuated between −100 mV/cm and 0 mV/cm, while the redox potential of the second bioreactor was almost always positive and fluctuated between 0 mV/cm and +100 mV/cm.

The bioreactors were found to achieve a complete conversion of acetate. In the first bioreactor the conversion of acetate at the end of the example period was approximately 100%. The decrease in acetate concentration in bioreactor 1 occurs as a result of increased heterotrophic biomass or increased activity of the existing heterotrophic biomass.

FIG. 2 charts the variation in sulphate and thiosulphate concentrations in the first and second bioreactors as the example progresses. The first bioreactor converts the sulphide anions into sulphate and thiosuphate according to reactions (3) and (6) respectively. The sulphate concentration increases from the first to the second bioreactor. Despite the high redox potential of the first bioreactor, elemental sulphur was also formed according to reaction (4).

The thiosulphate concentrations in the first bioreactor were relatively low, as a result of thorough mixing of the spent caustic stream with the bioreactor contents. In addition, the high acetate conversion in the first bioreactor reduces the oxygen concentration, thus limiting the abiotic oxidation of sulphide anions to thiosulphate according to equation (7). Furthermore, the temporary reduction in the oxygen transfer lowered the oxygen concentration and inhibited thiosulphate formation, while still providing sufficient oxygen to allow full bioconversion of the sulphide to sulphate or sulphur according to reactions (3) and (4). For these reasons, the thiosulphate concentration in the first bioreactor was low, with a contribution to sulphide conversion of less than 1%.

The second bioreactor provided conversion of the residual thiosulphate to sulphate according to reaction (9), to produce final concentrations of thiosulphate of approximately 7 mg/l. Furthermore, the second bioreactor converted the elemental sulphur produced in the first bioreactor into sulphate according to reaction (8). The rate of the spent caustic fed to the first bioreactor during this period was 9.5 ml/hr. The sulphide concentration in the spent caustic varied from 19.8 to 17.6 g/l, producing an average sulphide load of 4.5 g/day. With a total volume of 4 l for the two bioreactors the conversion of sulphide was 1.25 g/l/day.

FIG. 3 shows the conversion of sulphate and thiosulphate in the first bioreactor and the overall efficiency of one embodiment of the method of the invention. FIG. 3A shows that the overall selectivity for sulphate formation is higher than 95%, meaning that more than 95% of the total sulphide ions (expressed in mol/l) in the influent to the bioreactor are oxidised to sulphate.

FIG. 3B shows that the thiosulphate produced in the first bioreactor is less than 0.5%, meaning that less than 0.5% of the total sulphide ions (expressed in mol/l) in the influent to the bioreactor are oxidised to thiosulphate. The thiosulphate produced in the first bioreactor is converted to sulphate in the second bioreactor as shown by the overall efficiency in FIG. 3B.

It can be seen from FIG. 3A that there is an initial decrease in sulphate conversion in the first bioreactor. This effect occurs due to a temporary reduction in oxygen transfer in the first bioreactor prior to an increase in sulphate conversion and steady state conditions being achieved. The initial reduction in the conversion of sulphide to sulphate is reflected in a relative increase in conversion to thiosulphate and sulphur. The increase in thiosulphate conversion can be seen in FIG. 3B for the same time period. The conversion of thiosulphate in the first bioreactor then decreases in step with the increase in conversion to sulphate in the first bioreactor shown in FIG. 3A.

The biomass concentration was between 175-275 mg/l in the first bioreactor and 207 mg/l (expressed as nitrogen) in the second bioreactor. Biomass concentration was measured as the amount of total N, based on the absorbance of nitrophenol at 370 nm with the Lange cuvette test LCK238 (Hach Lange, Düsseldorf, Germany). Prior to analysis, samples were centrifuged (10 min, 10,000 rpm) and washed two times with N-free medium to remove all dissolved N. This method was tested by standard addition of ureum and nitrate to reactor samples as well as fresh medium, with and without the presence. The chemical oxygen demand of the contents of the second bioreactor was measured after completion of the example. The COD content of the unfiltered sample was 3996 mg/l. It is apparent that elemental sulphur and the biomass accounts for the majority of the COD. This is because the COD attributed to thiosulphate and acetate is negligible because the concentrations of these species are so low.

The sulphate selectivity was determined to be approximately 95%, with the remaining 5% being sulphur formation. This results in 900 mg/l sulphur (calculated from the reactor influent and effluent concentrations). The COD content of sulphur is 2 g/g. Thus the COD attributed to sulphur is 1800 mg/l. The biomass therefore contributed 2196 mg/l to the COD.

The COD of the contents of the second bioreactor were then measured after separation by centrifugation. The COD of the supernatant was found to be 963 mg/l. This can be attributed to colloidal sulphur because the biomass is sedimented as a pellet. The COD content of sulphur is 2 g/g, such that the supernatant corresponds to 481.5 mg/l sulphur. Thus, approximately 50% of the sulphur particles are colloidal in nature.

Small amounts of colloidal sulphur were present in the effluent from the second bioreactor. In order to reduce the concentration of elemental sulphur and other suspended solids to meet the World Bank Group effluent discharge criteria shown in Table 1 above, a filtration step was carried out after the effluent was removed from the second bioreactor. A continuous microfiltration membrane filter was used to reduce the sulphur and total suspended solids content of the treated spent caustic to less than 30 mg/l, thereby producing a filtration effluent stream of treated water which meets the World Bank Group effluent discharge requirements.

Table 3 details characteristics of the spent caustic, effluent from bioreactor 1 (partially oxidised spent caustic), effluent from bioreactor 2 (treated spent caustic) and filtration effluent (treated water).

TABLE 3
Composition of spent caustic and process
effluents at outlet of Bioreactor 1 and 2

| | | | | Effluent |
|---|---|---|---|---|
| | | Effluent | Effluent | after |
| | Spent | Bioreactor | Bioreactor | filtration |
| | Caustic | 1 | 2 | step |
| pH | 9.8 | 9.9 | 8.5 (1) | 8.5 |
| Temperature | | 28 | 28 | 28 |
| (° C.) | | | | |
| Conductivity | 105 | 73 | 80 | 80 |
| (mS/cm) | | | | |
| COD | | | 4000 | |
| (mg/L) | | | | |
| TSS, sulfur | | 14000 | 900 | <30 |
| and biomass | | | | |
| (mg/l) | | | | |
| Sulfide | 13550 | <1 | <0.1 | <0.1 |
| (mg/l) | | | | |
| Thiosulphate | | 10 | 7 | 7 |
| (mg/l) | | | | |
| Sulphate | | 16000 | 23700 | 23700 |
| (mg/l) | | | | |

(1): pH is corrected by acid addition.

This Example shows that the provision of two bioreactors can be used to treat spent caustic to provide a treated spent caustic with low levels of thiosulphate. Furthermore, filtration of such treated spent caustic will reduce the levels of total suspended solids to those meeting the World Bank Group effluent discharge requirements.

The person skilled in the art will understand that the invention can be carried out in many ways without departing from the scope of the appended claims. For instance, rather than providing the spent caustic, water and nutrients to the first bioreactor are multiple supply streams, two or more of these supply streams can be combined into a single stream.

1. A method of biologically treating a spent caustic to provide a treated spent caustic, said method comprising the steps of:
(a) passing a spent caustic stream comprising water, alkali metal hydroxide and sulphide to a first bioreactor;
(b) biologically oxidising sulphide in the first bioreactor with sulphide-oxidising bacteria to form sulphur (S⁰) and sulphate to provide a partially oxidised spent caustic comprising sulphur (S⁰) and sulphate; and
(c) passing the partially oxidised spent caustic to a second bioreactor where at least a portion of the partially oxidised spent caustic is further oxidised with sulphide-oxidising bacteria to form sulphate from sulphur (S⁰) to provide a treated spent caustic comprising sulphate.

2. The method according to claim 1, wherein the first bioreactor and the second bioreactor are located in one vessel.

3. The method according to claim 2 wherein the partially oxidised spent caustic is substantially free of sulphide, comprising less than 10 mg/l sulphide.

4. The method according to claim 3 wherein the redox potential of one or both of the first and second bioreactors is controlled at a value above −300 mV versus a standard Ag/AgCl reference electrode.

5. The method according to claim 4 wherein the first and second bioreactors are operated as a continuous culture.

6. The method according to claim 5 wherein the sulphide-oxidising bacteria is of the general Thiobacillus, Thiomicrospira, and related organisms.

7. An apparatus for the biological treatment of a spent caustic comprising at least:
a first bioreactor having a first inlet for a spent caustic stream comprising water, alkali metal hydroxide and sulphide and a first outlet for a partially oxidised spent caustic stream comprising sulphate and sulphur (S⁰);
a second bioreactor having a first inlet connected downstream to the first outlet of the first bioreactor, and a first outlet for providing a treated spent caustic stream comprising sulphate;
wherein said first bioreactor comprises a first medium comprising a sulphide-oxidising bacteria which generates sulphur (S⁰) and sulphate from sulphide and said second bioreactor comprises a second medium comprising a sulphide-oxidising bacteria which generates sulphate from sulphur (S⁰).

8. The apparatus of claim 7 wherein the first outlet of the second bioreactor is connected to the first inlet of a separation device, which has a first outlet for a treated water stream.

9. The apparatus of claim 8 wherein the sulphide-oxidising bacteria is of a genera selected from the group consisting of Thiobacillus and Thiomicrospira.

10. The apparatus of claim 9 wherein one or both of the first and second bioreactors further comprise a redox device for controlling the redox potential of one or both of the first and second media.
